(19) United States
(12) Patent Application Publication
(10) Pub. No.: US 2018/0329618 A1
(43) Pub. Date: Nov. 15, 2018

(54) AGRICULTURAL MACHINE

(71) Applicant: CLAAS Tractor SAS, Velizy-Villacoublay Cedex (FR)

(72) Inventors: Jan Carsten Wieckhorst, Paderborn (DE); Christian Ehlert, Bielefeld (DE); Lennart Meyer, Aachen (DE); Jens Heydekorn, Harsewinkel (DE); Pierre Noyer, Munchen (DE)

(73) Assignee: CLAAS Tractor SAS, Velizy-Villacoublay Cedex (FR)

(21) Appl. No.: 15/975,098

(22) Filed: May 9, 2018

(30) Foreign Application Priority Data
May 10, 2017 (DE) 102017110109.8

(51) Int. Cl. G06F 3/0484; G06F 3/0482; G06F 3/0488; A01B 69/00; B62D 49/06

(52) U.S. Cl. CPC G06F 3/04847; G06F 3/0482; G06F 3/04886; G05D 1/0278; B62D 49/0614; G06F 2203/04803; A01B 69/007

(57) ABSTRACT

An agricultural machine, such as a tractor, includes a driver assistance system that has an input/output unit. The input/output unit carries out settings relating to an agricultural working task by an operator and displays virtual operating elements, allowing the settings and the displaying of information corresponding to the settings to be or have been made. The input/output unit allows for an interactive setting of at least one parameter of the agricultural machine and/or at least one working unit for implementing or supporting the agricultural working task, with the interactive setting being performed in a symbol-based and/or image-based or guided manner. Further, the at settable parameter, its value, or value range is preselected by the driver assistance system based on the agricultural working task selected, the working unit selected, or added on by the operator.

### CROSS REFERENCE TO RELATED APPLICATION

This application claims priority under 35 U.S.C. § 119 to German Patent Application No. DE 102017110109.8, filed May 10, 2017, the entire disclosure of which is hereby incorporated herein by reference.

### TECHNICAL FIELD

The technical field relates to an agricultural machine. More specifically, the technical field relates to an agricultural machine, such as a tractor, that allows an operator of the agricultural machine to set up the driver assistance system of the agricultural machine using virtual operating elements.

### BACKGROUND

EP 3 046 015 A1 discloses an agricultural machine in the form of a tractor which includes a driving support information display device. The driving support information display device includes different sections, including a status display area and a menu display area. The status display area has a plurality of status display sections (including status information relating to a functional module) arranged vertically in one side area of a display screen. The menu display area has an upper menu display area with a plurality of selection button sections arranged side by side in an upper area of the display screen and a lower menu display area with a plurality of selection button sections arranged side by side in a lower area of the display screen. The driving support information display device also includes a touchscreen for touch input.

### DESCRIPTION OF THE FIGURES

The present application is further described in the detailed description which follows, in reference to the noted plurality of drawings by way of non-limiting examples of exemplary implementation, in which like reference numerals represent similar parts throughout the several views of the drawings, and wherein:

FIG. 1 illustrates a schematic view of one implementation of the agricultural machine with a programmable driver assistance system; and

FIGS. 2A-6B illustrate a schematic side view of one basic sequence of interactive setting of parameters of the agricultural machine in FIG. 1.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

The driving support information display device disclosed in EP 3 046 015 A1 includes a plurality of hardware buttons and a touchscreen. Further, the purpose of the touchscreen is to show, in various status sections, the status of selected function modules. However, implementing settings of function modules or working devices does not take place in EP 3 046 015 A1 via the touchscreen, but via the hardware buttons, etc. Thus, in order to be able to adapt an agricultural machine and/or the respective working device to a specific agricultural working task, the operator must implement a number of settings via these operator elements, which is relatively complicated and time-consuming. There is also the risk of certain settings not being implemented, or not being implemented correctly. For example, certain settings may potentially have a large number of settings options. In this way, the operator may incorrectly select the certain settings, resulting in the agricultural working task being performed sub-optimally.

Thus, in one implementation, an agricultural machine is disclosed which simplifies the setting, by the operator, of at least one parameter of the agricultural machine and/or the working unit. In particular, the agricultural machine, which may comprise a tractor, includes a driver assistance system. The driver assistance system may include an input/output unit, which may be configured to perform any one, any combination, or all of: carrying out settings relating to an agricultural working task selected by an operator; displaying virtual operating elements allowing the settings; and displaying information corresponding to the settings that are to be and/or have been made. For example, the input/output unit may enable input using a symbol-based and/or image-based and/or guided manner. For example, the driver assistance system may preselect, based on the agricultural working task indicated by the operator and/or based on the working unit built on by the operator, one, some or all of: at least one settable parameter; its value; or value range.

In one implementation, the agricultural machine is a tractor. Alternatively, the disclosed solution may be used on any other type of agricultural machine, such as, for example, a combine harvester or a forage harvester. In this regard, any discussion below regarding a tractor may likewise be applied to any other type of agricultural machine, such as applied to a combine harvester or a forage harvester.

In one implementation, the agricultural machine comprises a driver assistance system, which may support the driver or the operator of the agricultural machine during one or more parts of operation of the agricultural machine, such as in order to configure the agricultural machine to perform an upcoming agricultural working task or in order to configure the agricultural machine while performing the agricultural working task. The driver assistance system may provide support in any one or any combination of several ways, including support relating to the driving and/or steering of the agricultural machine, and including control and/or regulation of at least one of the function modules. In one implementation, the term “functional module” may comprise components for operating the agricultural machine, such as a ballast device, tires or pairs of tires etc. connected internally or permanently to the agricultural machine, as well as working units internally or permanently connected to the agricultural machine for carrying out or supporting agricultural work, such as drive motors (e.g., operation), gearboxes etc. In an alternate implementation, the term “function module” may also include external or attachable working units for carrying out or supporting agricultural works (e.g., add-on devices to the agricultural machine), such as, for example a plough, a baling press, front loader bucket, etc.

In one implementation, the input/output unit enables one or both of: interactive setting of at least one parameter of the agricultural machine; and at least one working unit thereof can be performed in a guided manner and based on symbols and/or images. Unlike previous solutions, the operator does not have to use a vast number of hardware buttons, switches, slide controls, rotary controls and the like, which are often very similar to each other and may therefore confuse the operator. Instead, the input/output unit may generate, in a predetermined and/or preselected way, virtual operating elements and symbols and/or pictures. The system may thus use these virtual operating elements and symbols and/or pictures in guiding the operator through one or more steps for setting a relevant parameter, thereby making the sequence of setting related to the relevant parameter (e.g., the setting of the parameter, including selection of the parameter, the value of the parameter, and/or the value range of the parameter) intuitive to the operator.

In one implementation, the driver assistance system may preselect the setting related to the parameters, such as preselect any one, any combination, or all of: the at least one settable parameter (which may be selected from a plurality of available parameters for selection); the value of the parameter; or the value range of the parameter. In one implementation, the operator may select any one, any combination, or all of: the agricultural working task; or the working unit (e.g., the working unit selected and/or added on or used by the operator). Responsive to the operator selecting the agricultural working task and/or the working unit, the driver assistance system may select (such as preselect) the setting related to the parameter such as selecting the at least one settable parameter, the value of the parameter, and/or the value range of the parameter.

Thus, in one implementation, the input/output unit may initially provide the operator the opportunity of selecting an agricultural working task. In a first specific implementation, the input/output unit may generate a plurality of available agricultural working tasks from which the operator may choose. In a second specific implementation, the input/output unit may generate a screen through which the operator may enter the desired agricultural working task without suggestion by the input/output unit. Responsive to the operator selecting the agricultural working task, the system (such as the input/output unit) may then automatically specify (e.g., only show) to the operator any one, any combination or all of: the relevant parameter(s) (e.g., the one or more parameters shown to the operator being selected based on the agricultural working task selected by the operator), the value(s) for a respective parameter (e.g., the one or more values shown to the operator being selected based on the agricultural working task selected by the operator); or the value range(s) for the respective parameter (e.g., the one or more value ranges shown to the operator being selected based on the agricultural working task selected by the operator). Alternatively, or in addition, the working unit, which is to be used in an agricultural working task, may initially be specified or indicated to the agricultural machine. The indication of the working unit may be made in one of several ways. In one way, the operator may indicate or select the working unit via the input/output unit. Alternatively, or in addition, the working unit may be connected to the agricultural machine. Responsive to the connection of the working unit to the agricultural machine, the agricultural machine (such as the input/output unit of the agricultural machine) may determine that the working unit is specified or indicated. Responsive to the indication or specification of the working unit, the system (such as the input/output unit) may then automatically only show to the operator any one, any combination or all of: the relevant parameter(s) (e.g., the one or more parameters shown to the operator being selected based on the working unit indicated and/or the agricultural working task selected by the operator), the value(s) for a respective parameter (e.g., the one or more values shown to the operator being selected based on the working unit indicated and/or the agricultural working task selected by the operator); or the value range(s) for the respective parameter (e.g., the one or more value ranges shown to the operator being selected based on the working unit indicated and/or the agricultural working task selected by the operator).

Through the disclosed driver assistance system and the input/output unit, the agricultural machine enables the operator simplified setting or modification of operation of the agricultural machine. Specifically, the agricultural machine may enable easier work task-specific or work unit-specific preselection or settable parameters and/or values or value ranges, thereby making the operator configuration of the agricultural machine easier.

In one implementation, the input/output unit comprises a touchscreen, thereby particularly simplifying the interactive setting of the operation (e.g., the selection of the parameters, values, and/or value ranges). For example, the touchscreen allows symbol and/or image-based and guided interactive settings to be input in a particularly simple manner, such as more easily setting the at least one parameter of the agricultural machine and/or working unit. The touchscreen may be arranged in the interior of the agricultural machine, such as inside the cab of the agricultural machine. Alternatively, or in addition, the input/output unit may be positioned on the outside of the agricultural machine (e.g., outside of the cab of the agricultural machine). For example, the input/output unit may be positioned in the vicinity or in sight of the respective working unit or add-on device. In one implementation, the work task-specific setting and/or work unit-specific setting of the agricultural machine is performed on a device external to the agricultural machine, such as an (external) computer or PC, and is transmitted (such as via telemetry or wirelessly) to the agricultural machine (e.g., to the input/output unit and/or to the driver assistance system of the agricultural machine).

The input/output unit, such as the touchscreen, may have one or more display sections which may show different information and/or virtual operating elements. Various virtual operating elements are contemplated. For example, one virtual operating element may comprise an illustration or representation of the agricultural machine itself, such as a silhouette or outline of the tractor in the example of the agricultural machine comprising a tractor. Further, input/output unit may generate outputs in a symbol-based and/or image-based manner. For example, internal and/or external working units and/or further function modules of the agricultural machine may be shown on the input/output unit in a symbol-based and/or image-based manner. In this way through such optical illustration, intuitive setting is facilitated, so that a more easily understandable selection of functions to be set is provided. Further, after an agricultural working task and/or working unit has been specified to the driver assistance system, the input/output unit may guide the operator by a clear menu through the work task-specific or work unit-specific parameter, which are to be set so that the agricultural machine may perform the agricultural working task and/or working unit.

In one implementation, the display section of the input/output unit comprises one and the same display section. In an alternate implementation, the display section of the input/output unit comprises different display sections. Thus, the display section optically displays any one, any combination, or all of: a display section that optically displays an image of the agricultural machine and/or at least one working unit of the agricultural machine forming a first function module and/or of the ground to be traveled; a display section that optically displays an image of at least one further function module of the agricultural machine; a display section that displays one or more selectable superordinate and/or subordinate working tasks and/or one or more selectable working units and/or one or more adjustable parameters of the agricultural machine and/or of the at least one working unit in a symbol-based and/or an image-based and/or a text-based manner; a display section that displays the selected agricultural working task and/or the working unit and/or the at least one set or stored parameter and/or its value or value range in a symbol-based and/or an image-based and/or a text-based manner; in one display section of the input/output unit, the at least one function button and/or a warning is displayed in a symbol-based and/or an image-based and/or a text-based manner; and in one display section of the input/output unit, a field or symbol and/or image for a reset entry is shown.

As discussed previously, the working machine may comprise various other function modules in addition to the working unit, such as the add-on unit. In one implementation, the function modules may comprise any one, any combination, or all of: a front ballast device; a front tire pair; a rear tire pair; a drive motor; a gearbox; and a GPS system. The respective further function module can also be shown optically or in a symbol and/or image-based manner in a display section of the input/output unit.

Through the disclosed input/output unit, the operator has the opportunity to select a superordinate agricultural working task which defines one type of work, and subsequently, if applicable, a corresponding subordinate agricultural working task which defines a subordinate working task. For example, the input/output unit may generate one or more screens in order for the operator to select the superordinate agricultural working task and the corresponding subordinate agricultural working task. In particular, the input/output unit may show the respectively selectable agricultural working task and/or the agricultural working task selected by the operator. Example superordinate agricultural working tasks include, but are not limited to, any one, any combination, or all of: “cultivation”; “fodder harvesting”; “construction site”; “material handling”; “forestry work”; “transport”; and “others”. As one example, a superordinate agricultural working task comprises “cultivation”. A subordinate agricultural working task defining a subordinate type of work to the superordinate agricultural working task “cultivation” includes any one, any combination, or all of: “ground/soil working”; “sowing”; “planting”; “plant protection”; “fertilizing”; “manure and dung”; “harvesting”; and “stubble breakage”. As another example, a superordinate agricultural working task comprises “fodder harvesting”. A subordinate agricultural working task defining a subordinate type of work to the superordinate agricultural working task “fodder harvesting” includes any one, any combination, or all of: “grassland management”; “harvesting”; “grassland care”; and “silage”. As still another example, a superordinate agricultural working task comprises “other”. A subordinate agricultural working task defining a subordinate type of work to the superordinate agricultural working task “other” includes any one, any combination, or all of: “construction site”; “material handling”; “forestry work”; “transport”; and “communal work”.

The selectable subordinate working tasks may also be predefined for the operator as the first possible setting after the start of the setting routine so that the operator does not have to previously select a superordinate working task. Alternatively, the operator may initially select the superordinate, and thereafter select the subordinate working task.

In one implementation, the input/output unit displays to the operator at least one working tool which is assigned to the agricultural working task. As discussed above, various example superordinate agricultural working tasks are disclosed, and corresponding subordinate tasks are disclosed. For example, for the superordinate agricultural working task “cultivation” and/or the corresponding subordinate working task “ground/soil working”, the input/output unit may show a plough and/or cultivator as the allocated working unit. As another example, for the superordinate agricultural working task “fodder harvesting” and/or the corresponding subordinate working task “grassland management” and/or “harvesting”, the input/output unit may show a hay tedder or baling press as the allocated working unit. These examples are merely for illustration; other examples of a working unit assigned to an agricultural working task are contemplated.

In one implementation, responsive to connecting the working unit to the agricultural machine (e.g., mechanically connecting and/or networking connecting (e.g., a wired or wireless data connection)), the agricultural machine may automatically identify the respective working unit. Responsive to the agricultural machine automatically identifying the respective working unit, the agricultural machine may automatically preselect any one, any combination, or all of: parameter(s); value(s); value range(s); or agricultural working task. As discussed above, in one implementation, the operator may identify the agricultural working task, such as selecting the agricultural working task from a list in the input/output unit or by submitting the agricultural working task. Alternatively, responsive to the connection of the working unit to the agricultural machine, which may be an add-on device, the input/output unit may determine the agricultural working task without input from the operator and automatically implement the determined agricultural working task. Alternatively, or in addition, the input/output unit may determine the agricultural working task without input from the operator, and present the determined agricultural working task to the operator for selection or confirmation. After selection or confirmation by the operator, the input/output unit may implement the selected agricultural working task.

The input/output unit may display various parameters may be used. The input/output unit may display operating parameters of the agricultural machine and/or environmental parameters of the terrain. Responsive to display of the parameters, the operator may select and/or adjust the displayed parameters. In one implementation, these parameters may at least partially be stored or recorded by the agricultural machine. Various aspects of the parameters provided to the input/output unit may be recorded or stored including any one, any combination, or all of: the parameter; the value; or the value range. In this way, the recorded or stored information may also form the basis of the working unit-specific and/or working task-specific setting of the driver assistance system (so that the stored data may be used for subsequent configurations) and/or only be used as information for the operator. Example operating parameters include, but are not limited to: the weight of the front ballast device; the weight of the rear ballast device; the weight of the pairs of tires; the tire type and/or air pressure of the front pair of tires; the tire type and/or air pressure of the rear pair of tires; a strategy for automatic tire pressure adjustment; a crawling behavior strategy; a power requirement strategy; a processing quality strategy; a soil protection strategy; a driving comfort strategy; a strategy for power hop behavior; drive motor and/or gearbox parameters; cab data; oil circulation data; sequence management data; and fleet data. Examples of an environmental parameter including, but are not limited to: the presence or non-presence of a field; the soil type; the soil condition; the soil moisture content; the harvesting crop; the harvesting crop moisture content; weather data; GPS data and/or the degree of hilliness of the terrain. Other examples are described below.

In one implementation, the driver assistance system may operate in one or more modes, such as a preparation mode and at least one operating mode. Further, the driver assistance system may be switched between the preparation mode and at least one operating mode. The preparation mode allows the interactive setting to be carried by way of the input/output unit. Additionally, or alternatively, the operating mode allows the at least one operating parameter and/or environmental parameter to be stored or recorded and/or displayed while the agricultural working task is being performed. In one implementation, in addition to the preparation mode, at least two operating modes, including one operating mode for field work (e.g., operating field mode) and one operating mode for travelling on roads (e.g., operating travel mode), are provided. Depending on the selected mode, the operator is shown only the assigned information and selection options by the input/output unit.

In one implementation, the agricultural machine may store parameter(s), including any one, any combination, or all of: one or more of the aforementioned parameters; one or more of the work task-specific; or one or more of work unit-specific profiles. In a subsequent setting procedure, such stored data (including one or more parameters) may additionally or alternatively also be accessed. Further, in one implementation, the input/output unit may hide some of the stored data during the subsequent setting procedure. In this way, the input/output unit may provide certain values or value ranges as “best practice” for a subsequent setting process. Further, with regard to hiding values, values or value ranges which have led to a poor working results can be hidden accordingly. Storage of work task-specific and/or work unit-specific profiles makes particularly rapid setting of the agricultural machine and/or of the working unit possible.

Further, in one implementation, depending on the selected mode (e.g., preparation mode, respective operating mode) and/or the respective working task and/or working unit, the input/output unit may show only specifically assigned display sections and/or information. Therefore, depending on any one, any combination, or all of the mode, working task, or working unit, the input/output unit may show the operator specific sub-menus in order to simplify the setting process.

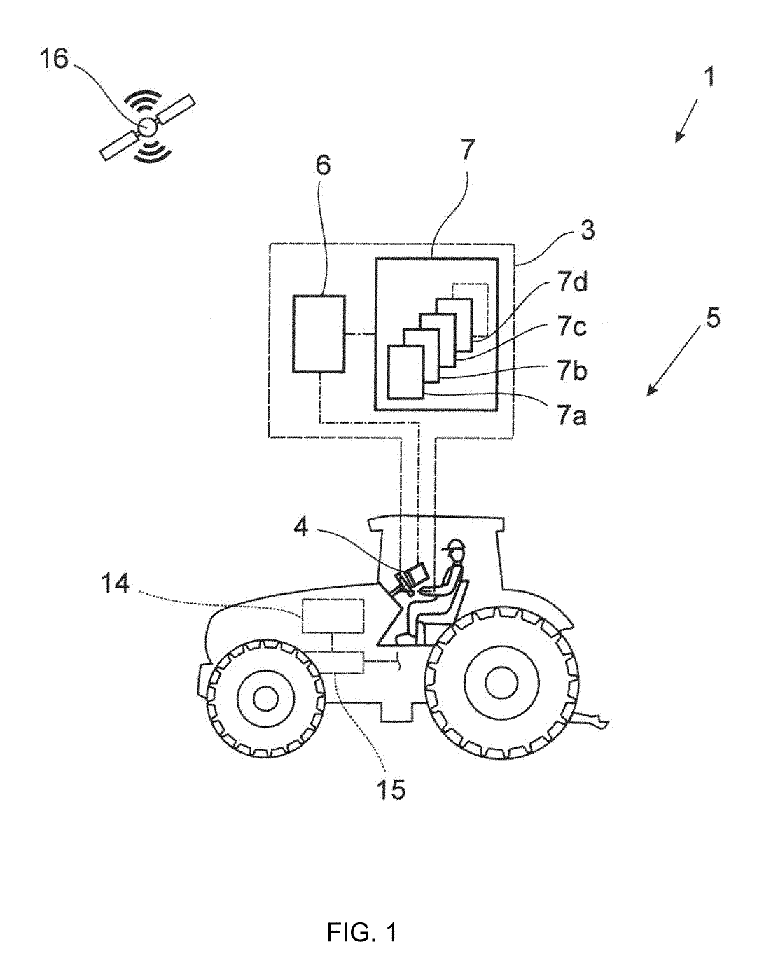

Referring to the figures, FIG. 1 illustrates a schematic view of the agricultural machine 1 with a programmable driver assistance system 3. The disclosed agricultural machine 1 permits the interactive setting of one or more parameters of the agricultural machine 1 and/or one of more working units 2 for carrying out or supporting an agricultural working task. For this function, the agricultural machine 1 has a driver assistance system 3 with an input/output unit 4 which is described in more detail below. The input/output unit 4 allows symbol and/or image-based and guided setting of the parameter(s), wherein the respective settable parameter and/or its value or value range is preselected by the driver assistance system 3 for an agricultural working task selected by the operator and/or for a working unit 2 selected and/or added on or used by the operator.

FIG. 1 shows how an agricultural machine 1 for carrying out a specific agricultural working task is prepared in terms of programming. Here, for example, the agricultural working task to be performed is soil working by means of a cultivator. The cultivator, which is one example of the working unit 2 for carrying out the agricultural working task, is not yet connected to the agricultural machine 1 illustrated in FIG. 1. In one implementation, the interactive setting of the parameters of the agricultural machine 1 or the working unit 2, and thereby the programming of the driver assistance system 3 is performed before the respective working unit 2 is attached. Alternatively, the respective working unit 2 may first be attached and the interactive setting/programming is only performed thereafter.

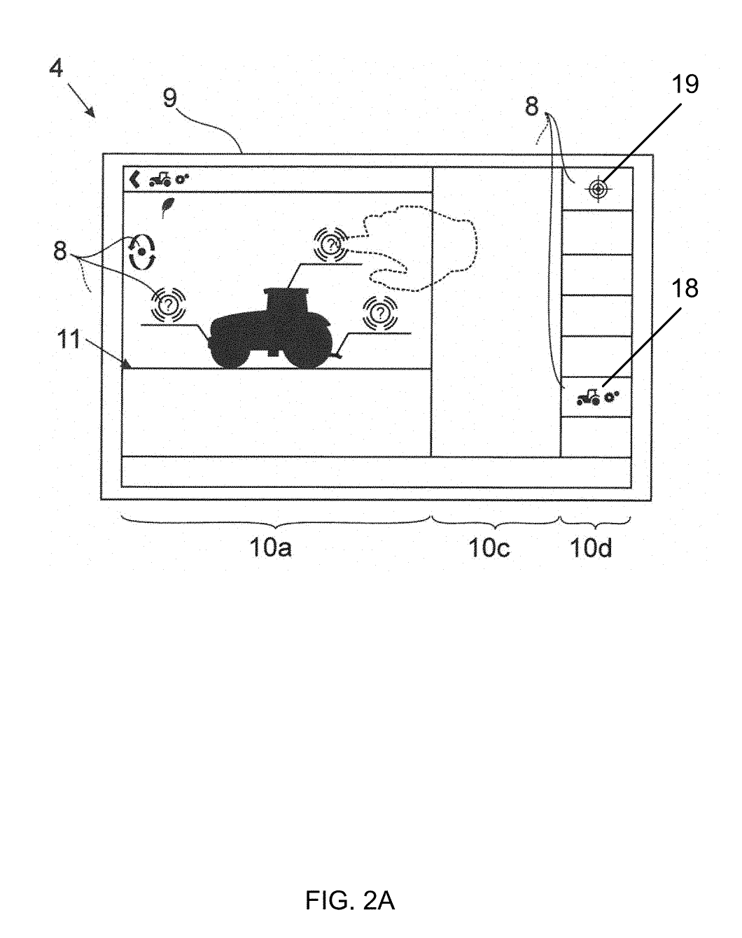

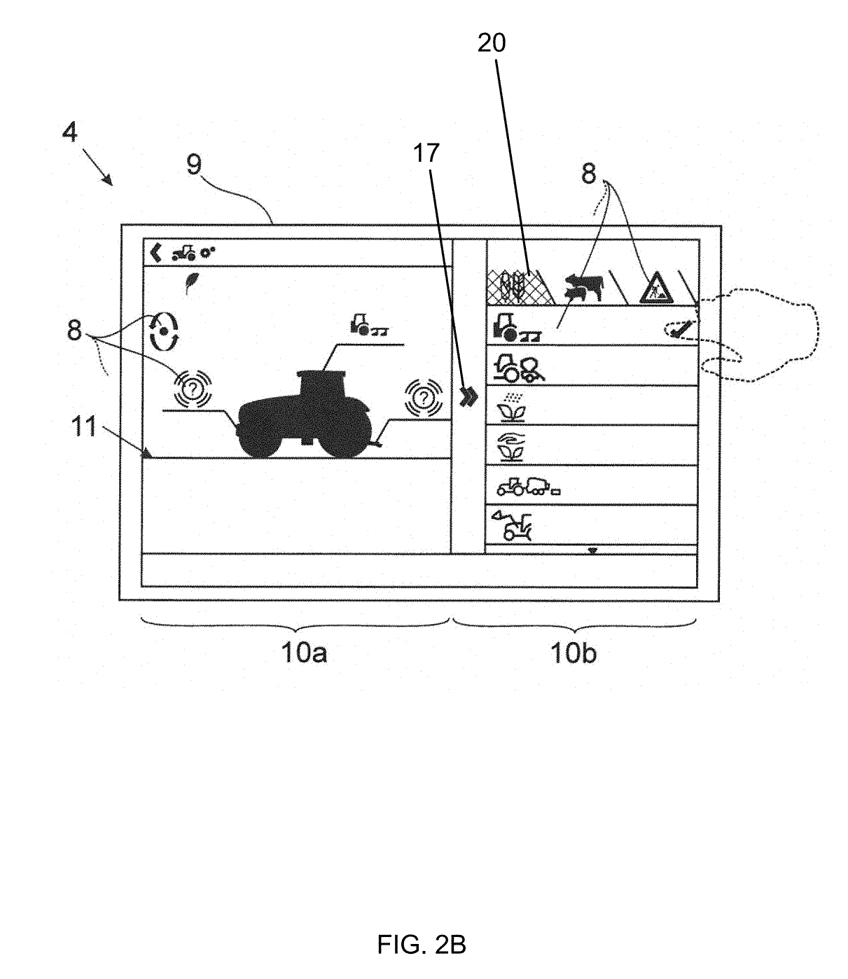

In the disclosed agricultural machine 1, in one implementation, the interactive setting of the parameters of the agricultural machine 1 and/or the respective agricultural unit 2 may be performed in a symbol and/or image-based and guided manner, which is described below with respect to FIGS. 2A to 6B by way of example. In one implementation, symbol-based and/or image-based means that one, some or all settings options of the operator is/are optically shown by means of a distinct symbol or image, and for selecting this settings option, the operator does not necessarily have to read and/or enter text. Guided may mean that the driver assistance system 3 or the input/output unit 4 initially provide the operator with various selection options and after the operator has selected one of these options, moves this to an assigned further selection field or sub-menu in which only parameters which relate to the prior selection can be set. Parameters of no relevance to the prior selection but which may possibly be relevant for other cases are preferably hidden here, or the operator is prevented from changing irrelevant parameters in another way. The operator may thus be guided through the interactive setting routine as a function of a selected agricultural working task and/or selected working unit 2 to be used. After the operator has selected an agricultural working task, the driver assistance system 3 or the input/output unit 4 may therefore automatically makes a preselection of parameters and/or allocated values and value range, which can be adjusted in this case. Only work task-specific parameters or values or value ranges for setting, that relate to the selected agricultural working task, are therefore shown to the operator. Parameters which do not relate to the selected agricultural working task and which relate to other agricultural working tasks are not displayed. In one implementation, parameters which, though relating to the specifically selected working task are predetermined by the system and should not be able to be adjusted, are also not shown to the operator. Alternatively, in the event that the preselection by the operator does not determine an agricultural working task, but directly determines a working unit 2 to be used, the system may then only provide working unit-specific parameters and/or values or value ranges for setting related to the determined working unit 2 to be used.

The input/output unit 4 may be integrated in the agricultural machine 1 in one of several ways. For example, FIG. 1 shows that a component of the driver assistance system 3 (shown by the broken line) is the input/output unit 4 as well as the microprocessor 6 and a storage medium 7. Alternatively, the input/output unit 4 may be separate from the driver assistance system 3.

The microprocessor 6 may comprise a type of controller, such as processor, a microcontroller, an Application Specific Integrated Circuit (ASIC), Programmable Logic Device (PLD), or Field Programmable Gate Array (FPGA), or the like. Storage medium 7 may comprise one or more types of storage medium, such as volatile memory and/or non-volatile memory. Further, microprocessor 6 and storage medium 7 may be separate devices, communicating via an external bus. Alternatively, microprocessor 6 and storage medium 7 may be within the same device, communicating via an internal bus. Logic, such the functionality described here, may be implemented in software stored in storage medium 7 and/or stored within microprocessor 6, as discussed further below.

The input/output unit 4 is a unit comprising components configured to carrying out settings relating to an agricultural working task by an operator and configured to display the virtual operating elements 8 allowing the settings and for displaying information corresponding to the settings that are to be and/or have been made. In one implementation, the input/output unit 4 comprises a touchscreen 9 with which interactive setting of the respective parameter may be performed. Additionally, as part of the input/output unit 4, input/output means (which are not shown) may be provided on the outside of the agricultural machine 1 (such as outside of the cab of the agricultural machine 1).

As shown schematically in FIG. 1, the storage medium 7 stores several working task-specific and/or working unit-specific storage packages 7a, 7b, 7c, 7d, i.e. storage packages 7a, 7b, 7c, 7d which are each assigned to a specific working task and/or a specific working unit 2. After a working task or working unit 2 has been specified to the driver assistance system 3, an appropriate one of the storage packages 7a, 7b, 7c, 7d is accessed from storage medium 7, with the storage packages 7a, 7b, 7c, 7d including one or more preselected adjustable parameters and/or associated values or value ranges. The respective storage package 7a, 7b, 7c, 7d may also include parameters and/or values or value ranges predetermined by the system which cannot be changed by the operator.

Here, an agricultural working task and/or working unit 2 is specified by the operator, such as through a symbol and/or image-based and guided selection of a working task or working unit 2 from a group of selectable agricultural working tasks or working units 2. Additionally, or alternatively, the working unit 2 is specified without operator input. For example, responsive to the respective working unit 2 being connected to the agricultural machine 1 (e.g., connected to the agricultural machine 1 via a mechanical connection and/or a wired or wireless data connection), the agricultural machine may identify the respective working unit 2. Specifically, in this latter case, the driver assistance system 3 and/or the input/output unit 4 may automatically recognize the respective working unit 2 and then show to the operator on input/output unit 4 the preselected, adjustable parameters or values or value ranges which can still be changed with regard to the corresponding agricultural working task.

An interactive setting of parameters of the agricultural machine 1 is described below by way of example. Other interactive settings of the parameters are contemplated. As can be seen in FIGS. 2A to 6B, for this purpose, the input/output unit 4 has multiple display sections, such as display sections 10a, 10b, 10c, 10d which each show different information and/or operating elements 8. Thus, in the display section 10a shown on the left in FIGS. 2A to 6A, an image of the agricultural machine 1 and/or at least one working unit 2 of the agricultural machine 1 forming a first function module and/or of the ground 11 (with the part of the image at 11 forming a representation of the ground) to be traveled is optically displayed. In addition, in this display section 10a, the operator is shown each of the main selection options envisaged for interactive setting as a virtual operating element 8 in the form of a question mark. In this regard, the question mark correlated to a section of the agricultural machine 1 is an indicator to the operator of what parameters are to be set. Furthermore, in this section 10a, there is a virtual operating element 8 in the form of two arrows running counter-clockwise about a midpoint to symbolize a reset element. The selected travel strategy for the respective working task can also be shown in a symbol and/or image-based manner in the display section 10a, here for example in the form of a leaf or plant for an energy-saving travel strategy.

As can be seen from a comparison of FIG. 2A on the one hand with FIGS. 2B, 3B and 5B on the other hand, the display section 10a is also for the symbol, image and/or text-based display of a working task specifically selected by the operator and/or specifically selected working unit 2 and/or specifically set or recorded parameter or associated value or value range.

In a second display section 10b which is shown in FIGS. 2B, 3B, 4B and 5B, the selection and setting options subordinate to the main selection option can be shown. The display section 10b may only be shown if entries by the operator are required. Via a virtual operating element 8 in the form of a double arrow 17 point to the right, the display section 10b can also be temporarily reduced in size or removed. The display section 10b is for the symbol, image and/or text-based display of several selectable superordinate and/or subordinate working tasks and/or selectable working units and/or selectable parameters of the agricultural machine 1 or the agricultural machine unit 2.

In FIGS. 2A, 3A, 4A, 5B and 6A, two further examples of display sections are shown, for example a display section 10c for showing information about the function modules. Also considered as functional modules in addition to the added-on working unit 12 are, for example, a front or rear ballast device 12a, 12b, a front or rear pair of tires 13a, 13b, a drive motor 14, a gearbox 15 and/or a GPS system 16. Information relating to functional modules can be the tank content, average consumption, the added-on working unit 2, the surface processed or to be processed, etc. In this display section 10c, function keys, warning and/or information not relating to the actual setting procedure can also be shown.

In yet another display section 10, shown in FIGS. 2A, 3A, 4A, 5B and 6a on the right-hand side, virtual operating elements 8 are shown with which various programming and/or display modes can be selected. A virtual operating element 8 in the form of a tractor silhouette with toothed wheels 18 symbolizes a selection button for the interactive setting of parameters of the agricultural machine 1. With this, the operator may call up the setting routine in question. A virtual operating element in the form of cross-hairs 19 symbolizes a selection button for setting optimization parameters, in particular optimization parameters relating to the selected working task and/or working unit 2.

FIG. 2A shows the start of the example setting routine for the interactive setting of parameters of the agricultural machine 1 and/or working unit 2 by means of the input/output unit 4. For this, the operator has initially called up the setting routine by pressing on the virtual operating element 8 with the tractor and toothed-wheel symbols 18 in display section 10d. Subsequently, as shown in FIGS. 2A and 2B, by pressing one of the virtual operating elements 8 in the form of the question mark, the operator is shown a menu in display section 10b via which it is possible to select superordinate and subordinated working tasks.

FIG. 2B shows that the superordinate agricultural working task “cultivation” has been preselected (upper row, symbol 20 on the left). In principle, the operator can also select other superordinate agricultural working tasks, for example the agricultural working task “fodder harvest” (upper row, middle symbol) or “construction site” (upper row, right symbol) as well as, if applicable, also “material handling”, “forestry work”, “transport”, “other” and/or a combination thereof. For each of these superordinate agricultural working tasks, the system specifies to the operator several allocated subordinate working tasks from which the operator can choose. FIG. 2B shows that for the superordinate agricultural working task “cultivation” for example, there can be subordinate tasks such as “ground/soil working”, “sowing”, “planting”, “plant protection”, “fertilization”, “manure and dung”, “harvesting”, “stubble breaking” and/or a combination thereof, wherein the operator in FIG. 2B is selecting the subordinate task “ground/soil working”.

If, instead, the operator were to decide on “fodder harvesting” as the superordinate agricultural working task, he/she could as a subordinate working task select, for example, one from the group comprising “grassland management”, “harvesting”, “silage” and/or a combination thereof. For the superordinate agricultural working task “others”, the subordinate working tasks could, for example, be a group comprising the agricultural working tasks “construction site”, “material handling”, “forestry work”, “transport”, “communal work” or combination thereof. In this way, the determination as to the superordinate agricultural working task may dictate the subordinate working task(s) displayed.

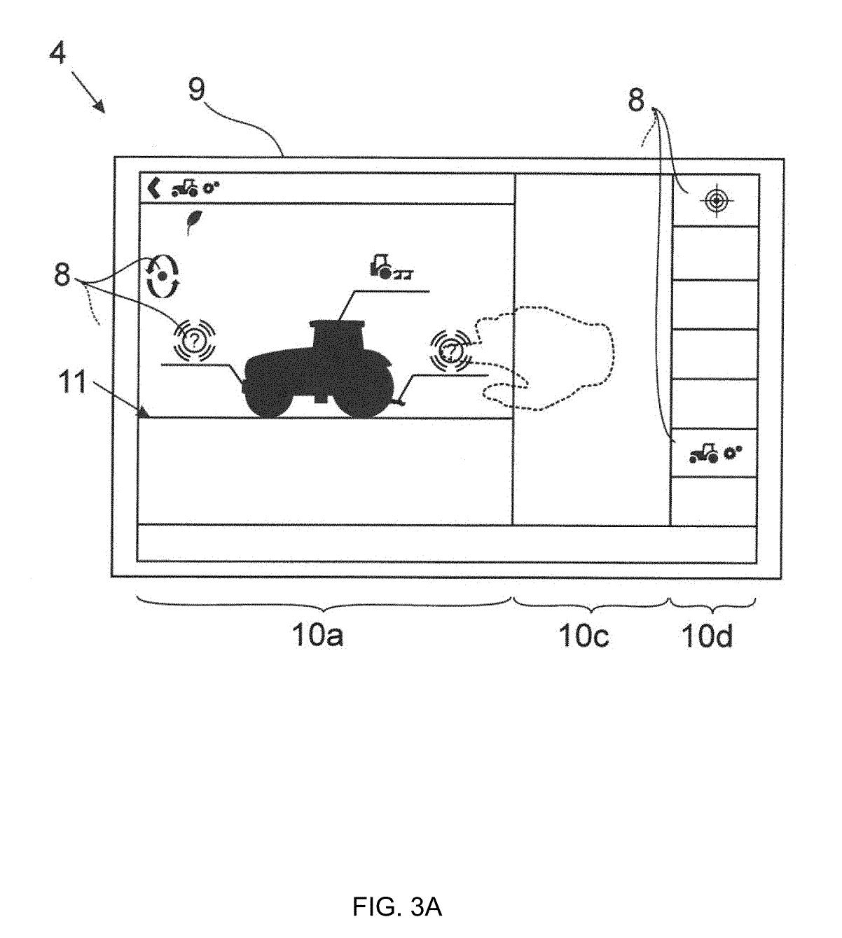

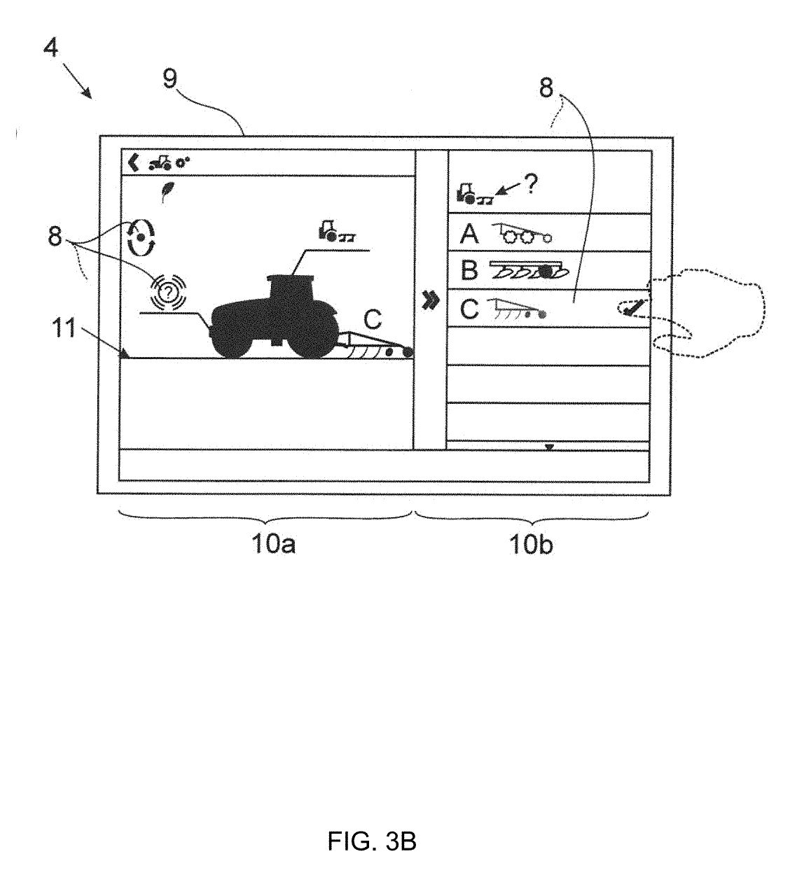

As shown in FIG. 3A, the operator can then select a working unit 2 subordinate or assigned to the previously selected working task, wherein the operator also presses a corresponding virtual operating element 8 in the form of a question mark and is then taken to a corresponding submenu. For example, as shown in FIG. 3A, configuration of a part of the system, such as the working unit 2, may be triggered by activation of an icon that is positioned at that part of the system. In this way, the operator may intuitively navigate amongst the different menus. In the sub-menu shown on the right side in FIG. 3B, the operator can, for example, chose between the working units “harrow” (A), “plough” (B) and “cultivator” (C), wherein here the operator is deciding on the cultivator. The assigned working units 2 for the other aforementioned working tasks will not be listed here in detail. In all cases, the respective working unit 2 is one which is assigned to one of the aforementioned respective working tasks.

The subordinate agricultural working tasks described here as an example which can be selected by the operator are shown here as a function of the previous settings of the respective superordinate agriculture working task. In principle, in an alternative implementation, however, it is possible to directly access the subordinate agricultural working tasks or working units 2.

After the agricultural working task and working unit 2 have been selected, which is then also shown in the first display section 10a in that both are shown optically or in a symbol or image-based manner, the operator now has the possibility of setting further parameters as a function of this working task and/or working unit 2, in this case and preferably operating parameters of the agricultural machine 1 and/or environmental parameters of the terrain.

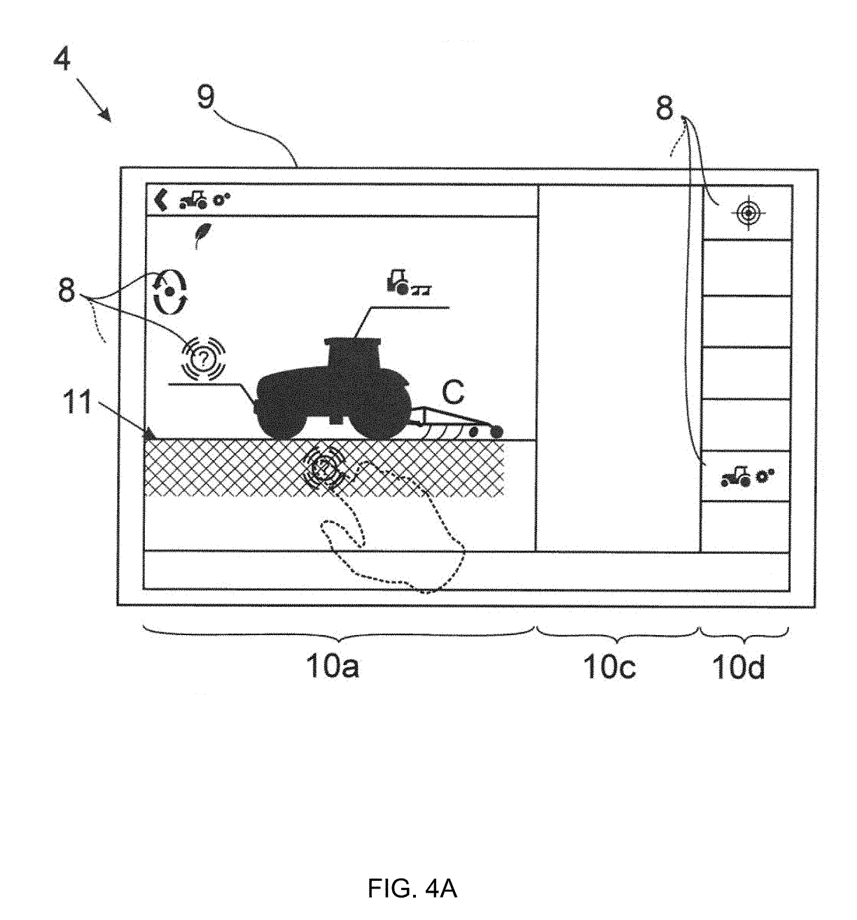

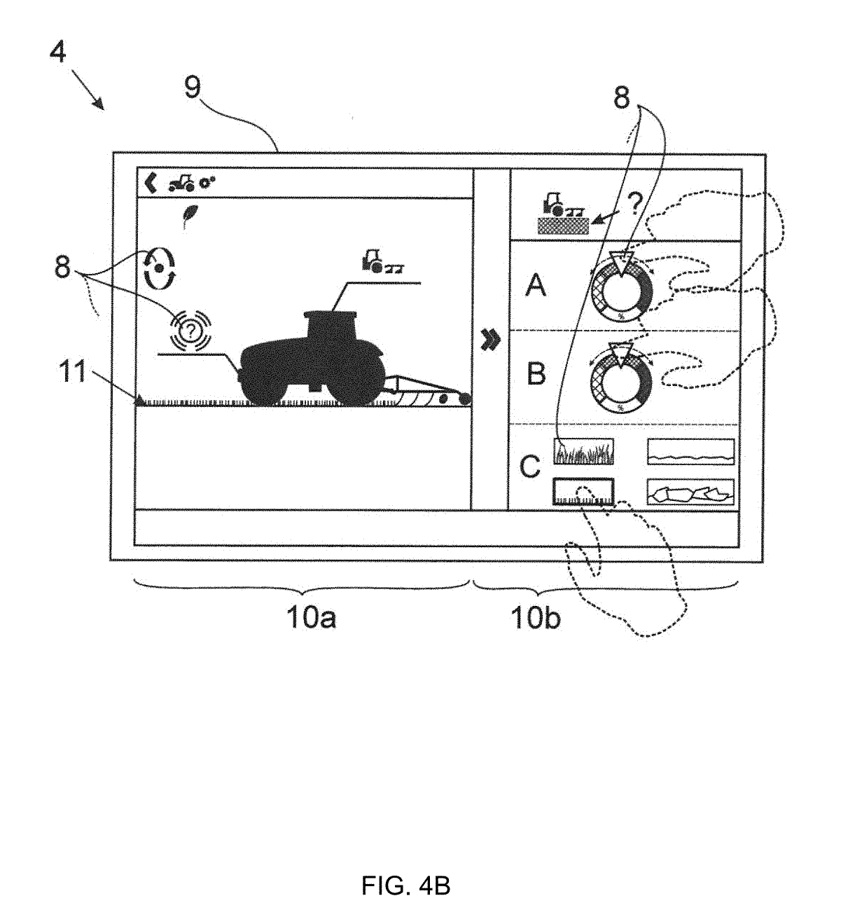

Thus, for example in FIG. 4A, the operator presses an optional virtual operating element 8 in the form of a question mark which opens a working task-specific and/or working unit-specific sub-menu for selecting soil conditions. Again, the pressing is on the portion of the image that is the soil, thus resulting in the sub-menu for selecting soil conditions. In this way, the soil type (A), the soil moisture (B) and/or the soil condition (C) of the ground (illustrated in FIG. 4B) to be worked can be determined. With regard to the soil type, the operator has the possibility of choosing here preferably between a light soil, a medium soil and a heavy soil. With regard to the soil moisture content, the operator can choose between a dry, medium-dry and moist soil. With regard to soil condition a choice between grassland, stubble field, deep-worked soil and shallow-worked soil can be made. Here, as can be seen in FIG. 4B, the operator is choosing a medium soil with a medium moisture content in a stubble field. The selection is then also shown in the first display section 10a. For example, the image displayed in of the ground 11 to be traversed is that of a stubble field.

Irrespective of the aforementioned soil conditions, further environmental parameters, such as also the presence and non-presence of a field, the type or harvested crop, the moisture content of the harvested crop, weather data, GPS data and/or the degree of hilliness of the terrain, may be shown, selected and/or adjusted. One, some or all of these parameters can additionally or alternatively be recorded or stored through suitable devices, for example sensor devices.

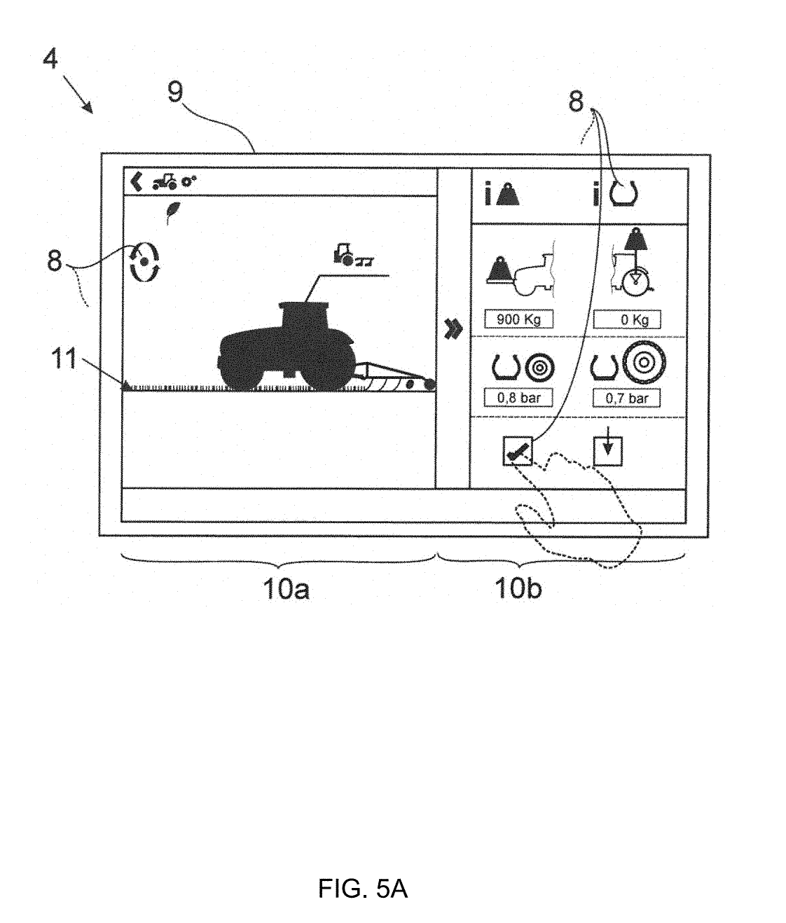

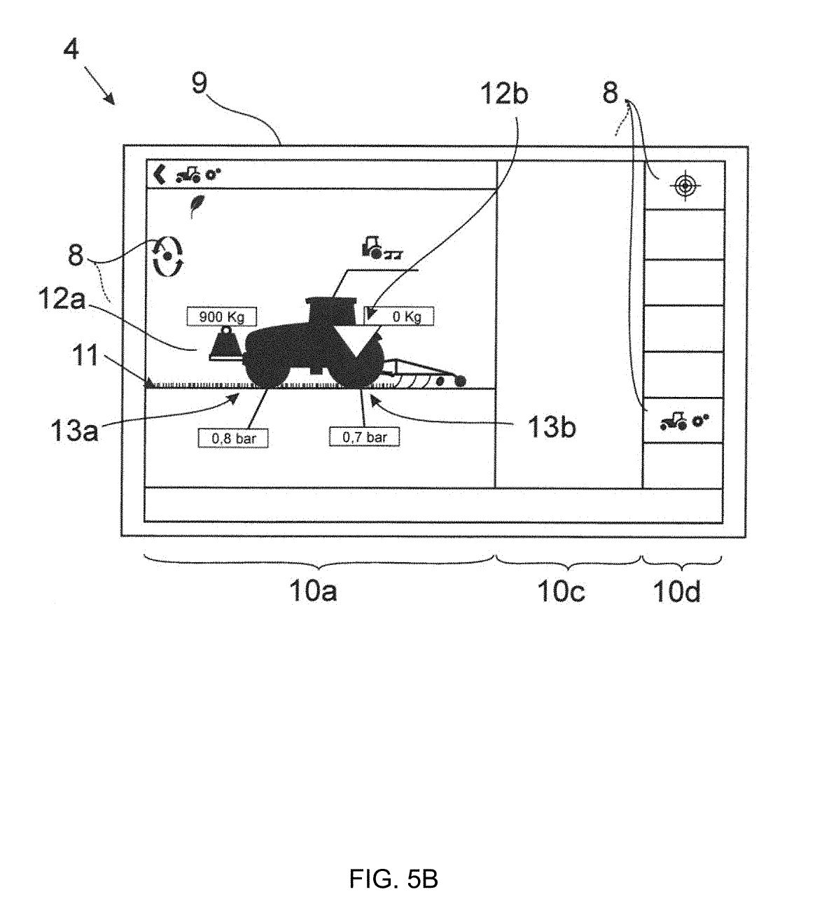

FIG. 5A shows a further options menu which is shown to the operator as a sub-menu as soon as the agricultural working task and/or working unit 2 is determined. Here operating parameters of the agricultural machine 1 can be adjusted, including the weight of a front ballast device 12a, the weight of a rear ballast device 12b, the air pressure of a front pair of tires 13a and/or the air pressure of a rear pair of tires 13b. In this case, the system is already suggesting values for the corresponding operating parameters, which only have to be confirmed by the operator. However, essentially the values can also be changed. This preferably applies to all parameters which are shown to the operator and can be adjusted. Here, as an example, for the front ballast device 12a a weight of 900 kilograms is determined, for the rear ballast device a weight of 0 kilograms, for the front pair of types an air pressure of 0.8 bars and for the rear pair of types an air pressure of 0.7 bars. After confirmation by the operator the determined operating parameters are also shown in the first display section 10a. For example, FIG. 5B shows the weight of the front ballast 12A of 900 kilograms (displayed in the portion of the image at the front of the agricultural machine 1), the weight of a rear ballast device 12b of 0 kilograms (displayed in the rear of the image at the back of the agricultural machine 1), the air pressure of a front pair of tires 13a of 0.8 bars (correlated on the display to the front tires in the image of the agricultural machine) and the air pressure of a rear pair of tires 13b of 0.7 bars (correlated on the display to the rear tires in the image of the agricultural machine).

Additionally, or alternatively, operating parameters, such as the pairs of tires, the tire type, drive motor and/or gearbox parameters, cab data, for example the desired cab temperature, data about the oil circulation, sequence management data and/or fleet data, may also be displayed, adjusted and/or selected. These data too can at least in parts be recorded by appropriate devices, such as for example sensor devices.

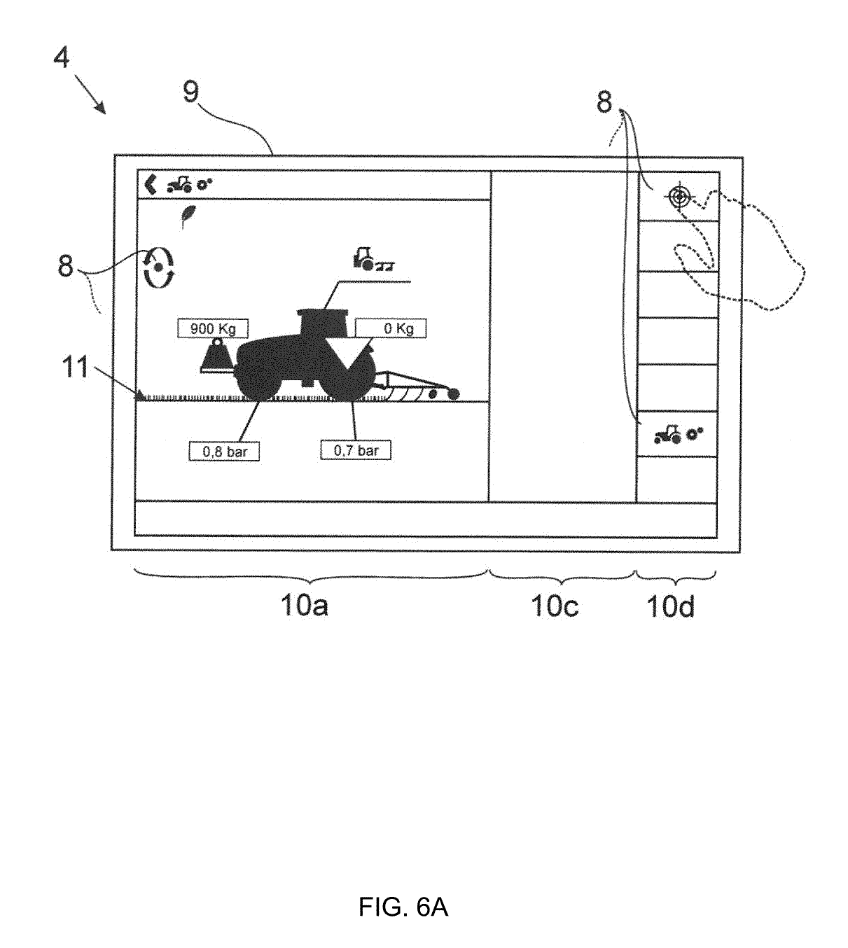

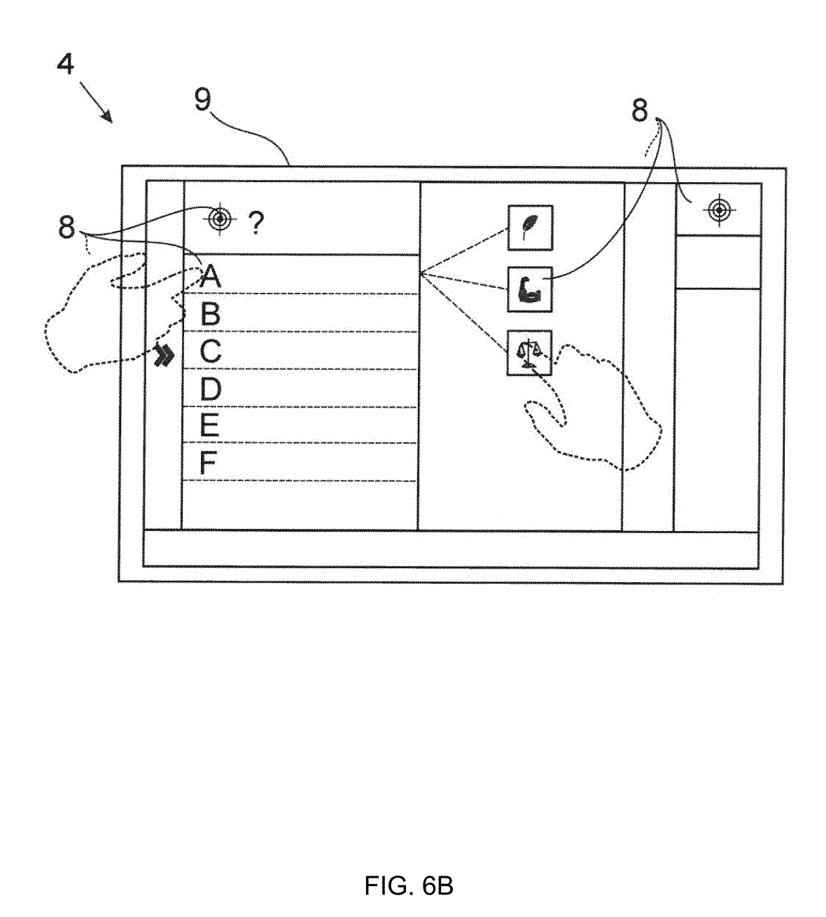

After these adjustments of various parameters have been performed, further optional optimizations can be performed, which, in particular, may be working unit-specific or working task-specific, and are displayed (e.g., the optional optimizations may be specially envisaged for the respective agricultural working task or the respective working unit 2). For this, the operator can press the upper virtual operating element 8, shown in FIG. 6A, in the right display section 10b, whereupon, for example, a sub-menu is shown as set out in FIG. 6B. Here, by pressing the virtual operating elements (A) to (F) further sub-menus can be opened. In the example illustrated in FIG. 6B, the operator selects a particular power requirement strategy. Responsive to selecting the particular power requirement strategy, a sub-menu appears. As shown in FIG. 6B, the sub-menu comprises three icons, with the top icon corresponding to a particularly energy-saving travel strategy, the middle icon corresponding to a travel strategy designed for power, and the lower icon corresponding to a balanced travel strategy. Thus, here for example, preferably also in a symbol and/or image-based manner, the selection can be made between a particularly energy-saving travel strategy, a travel strategy designed for power and a balanced travel strategy. As shown in FIG. 6B, the operator selecting the balanced driving strategy, for example.

The previously described settings of the driver assistance system 3 are all performed in a so-called preparation mode, which can be set via the input/output unit 4. For the subsequent performance of the corresponding agricultural working task, the driver assistance system 3 is switched via the input/output unit 4 into a corresponding operating mode, for example an operating mode for field work or an operating mode for travelling on roads, the latter in the event that the agricultural working task is performed on roads or on paved terrain. In the respective operating mode, some of the above-described parameters may be recorded by suitable devices of the agricultural machine 1 and can be then stored in a database of an internal and/or external storage medium 7. In such a database, work task-specific and/or work unit-specific profiles, in particular related to persons or an agricultural machine 1 can be stored. By calling up the stored data and in particular work task-related and/or work unit-specific profiles from the database or from the storage medium 7, a following setting procedure of the above-described type can be simplified or shortened. This can also be simplified in that frequently displayed/called up settings can be displayed before or via other settings in order to further speed up access thereto. Values or value ranges which have previously led to poor working results can also be hidden.

Additionally, or alternatively, particularly for optimization purposes, for example a strategy for automatic tire pressure adaptation, a creep behavior strategy, a processing quality strategy, a strategy for soil protection and the like can be selected and/or adapted. It is also contemplated to adapt the working efficiency, driving comfort or tendency to jerk when starting up (power hop behavior). This also takes place in a working task-specific and/or working unit-specific manner, preferably in the relevant operating mode. In one implementation, dialogue-based (manual) adaptation is performed.

### REFERENCE LIST

1 Agricultural Machine
2 Working units
3 Driver assistance system
4 Input/output unit
5 Tractor
6 Microprocessor
7 Storage medium
7a-7d Storage packages
8 Virtual operating elements
9 Touchscreen
10a-10d Display sections
11 Ground to be traversed
12a Front ballast device
12b Rear ballast device
13a Front pair of tires
13b Rear of tires
14 Drive motor
15 Gearbox
16 GPS system
17 Double arrow
18 Tractor silhouette with toothed wheels
19 Cross-hairs
20 Symbol for superordinate agricultural working task “cultivation”

Each of the items listed above may be associated with a single electronic device or may be combined within a single electronic device. Further, with regard to each separate electronic device, processing/memory functionality may be included. For example, any one, any combination, or all of the following may be in a single electronic device with associated with processing/memory functionality: input/output unit; driver assistance system; touchscreen; and GPS system.

The methods, devices, processing, circuitry, and logic described above may be implemented in many different ways and in many different combinations of hardware and software. As discussed above, a microprocessor 6 and a storage medium 7 may be used. The microprocessor 6 and a storage medium 7 are merely one example of a computational configuration. Other types of computational configurations are contemplated. For example, all or parts of the implementations may be circuitry that includes a type of controller, including as an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may implement the functionality described herein and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. An agricultural machine, the agricultural machine configured to work with a working unit, the working unit for implementing or supporting an agricultural working task, the agricultural machine comprising:
a driver assistance system comprises an input/output unit,
wherein the input/output unit configured to display one or more virtual operating elements, the one or more virtual operating elements enabling an operator to input one or more settings related to the agricultural working task,
wherein the input/output unit is configured to display information corresponding to the one or more settings to be made or previously have been made,
wherein the input/output unit is configured to receive input from an operator, the input indicative of the agricultural working task selected by the operator;
wherein the driver assistance system is configured to preselect at least one aspect associated with a parameter of the agricultural machine or the working unit based on the input indicative of the agricultural working task or based on an identification of the working unit; and
wherein the input/output unit is configured to output the preselected at least one aspect associated with the parameter and enable an interactive setting of the parameter using a symbol-based, an image-based, or a guided manner.

2. The agricultural machine of claim 1, wherein the at least one aspect associated with the parameter comprises the parameter, a value of the parameter, or a value range of the parameter.

3. The agricultural machine of claim 1, wherein the input/output unit is configured to output a representation of the agricultural machine;
wherein a first virtual operating element is associated with a first part of the agricultural machine;
wherein a second virtual operating element is associated with a second part of the agricultural machine, the first part of the agricultural machine being different from the second part of the agricultural machine;
wherein, responsive to selection of the first virtual operating element, a first menu is displayed, the first menu used for configuring the first part of the agricultural machine; and
wherein, responsive to selection of the second virtual operating element, a second menu is displayed, the second menu used for configuring the second part of the agricultural machine.

4. The agricultural machine of claim 3, wherein the first menu is configured to select superordinate and subordinated working tasks.

5. The agricultural machine of claim 1, wherein the driver assistance system is configured to preselect the at least one aspect associated with the parameter of the agricultural machine or the working unit based on the input indicative of the agricultural working task and based on the identification of the working unit; and
wherein the at least one aspect associated with the parameter comprises a value of the parameter or a value range of the parameter so that at least one of a preselected value of the parameter or a preselected value range of the parameter is output by the input/output unit.

6. The agricultural machine of claim 5, wherein the output of the at least one of the preselected value of the parameter or the preselected value range of the parameter is indicative to the operator to accept the at least one of the preselected value or the preselected value range; and
wherein responsive to the output, the operator is configured to input, via the input/output unit, confirmation of the at least one of the preselected value or the preselected value range.

7. The agricultural machine of claim 6, wherein the parameter comprises at least one of a correction signal setting, a selection of the working unit for performing the agricultural working task, or configuration of the working unit for performing the agricultural working task.

8. The agricultural machine of claim 1, wherein the input/output unit comprises a touchscreen.

9. The agricultural machine of claim 8, wherein the touchscreen is configured to display multiple sections which indicate different information and operating elements.

10. The agricultural machine of claim 9, wherein at least one display section of the input/output unit displays an image of the agricultural machine, the working unit of the agricultural machine forming a first function module, and a representation of ground upon which the agricultural machine is to travel;
wherein at least one display section of the input/output unit is configured to optically display an image of a second function module of the agricultural machine;
wherein at least one display section of the input/output unit is configured to output a plurality of selectable superordinate working tasks, a plurality of subordinate working tasks, a plurality of selectable working units, and a plurality of adjustable parameters of the agricultural machine and of the working unit; and
wherein at least one display section of the input/output unit is configured to output a selected agricultural working task, the working unit, a preselected parameter and a preselected value or a preselected value range.

11. The agricultural machine of claim 10, wherein the input/output unit is configured to output further function modules of a front ballast device, a rear ballast device, a front pair of tires, a rear pair of tires, a drive motor, a gearbox and a GPS system.

12. The agricultural machine of claim 10, wherein the plurality of selectable superordinate working tasks defining a type of work includes any one, any combination, or all of: “cultivation”; “fodder harvesting”; “construction site”; “material handling”;
“forestry work”; “transport”; or “others”.

13. The agricultural machine of claim 12, wherein the plurality of subordinate working tasks defining a subordinate type of work to the superordinate working task “cultivation” comprises one, some or all of: “ground/soil working”; “sowing”; “planting”; “plant protection”; “fertilizing”; “manure and dung”; “harvesting”; or “stubble breakage”.

14. The agricultural machine of claim 12, wherein the plurality of subordinate working tasks defining a subordinate type of work to the superordinate working task “fodder harvesting” comprises one, some or all of: “grassland management”; “harvesting”; “grassland care”; or “silage”.

15. The agricultural machine of claim 12, wherein the subordinate working task defining a subordinate type of work to the superordinate working task “other” comprises one, some or all of: “construction site”; “material handling”; “forestry work”; “transport”; or “communal work”.

16. The agricultural machine of claim 10, wherein the selected subordinate working task is shown as a first interactive setting or as a function of a previous setting of the subordinate working task.

17. The agricultural machine of claim 1, wherein the agricultural machine is configured to automatically recognize the working unit responsive to producing a mechanical connection or a data connection between the working unit and the agricultural machine.

18. The agricultural machine of claim 1, wherein the parameter comprises an operating parameter of the agricultural machine or an environmental parameter of a terrain;
wherein the parameter is selected from a group comprising weight of a front ballast device, weight of a rear ballast device, pairs of tires, tire type or air pressure, a strategy for automatic tire pressure adjustment, a crawling behavior strategy, a power requirement strategy, a processing quality strategy, a soil protection strategy, a driving comfort strategy, a strategy for power hop behavior, drive motor, gearbox, cab data, oil circulation data, sequence management data and fleet data; and
wherein the environmental parameter is selected from a group comprising presence or non-presence of a field, soil type, soil condition, soil moisture content, harvesting crop, harvesting crop moisture content, weather data, GPS data or degree of hilliness of the terrain.

19. The agricultural machine of claim 1, wherein the preselected parameter is based on previously recorded parameters; and
wherein the driver assistance system is configured to access a database for the previously recorded parameters.

20. The agricultural machine of claim 1, wherein the driver assistance system is configured to switch between a preparation mode, an operating field mode for field work and an operating travel mode for travelling on roads;
wherein the driver assistance system is configured to set the parameter in the preparation mode;
wherein the driver assistance system is configured to record the parameter in the operating field mode or the operating travel mode; and
wherein, depending on a respective mode, the input/output unit is configured to assign the agricultural working task and working unit to specific display sections.
